(19) United States
(12) Patent Application Publication
(10) Pub. No.: US 2006/0051142 A1
(43) Pub. Date: Mar. 9, 2006

(54) Fixing device and image forming apparatus

(75) Inventors: Mutsumi Naniwa, Shizuoka (JP); Chikashi Ohishi, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/218,765

(22) Filed: Sep. 6, 2005

(30) Foreign Application Priority Data
Sep. 6, 2004 (JP) 2004-258355

(51) Int. Cl. G03G 15/20

(52) U.S. Cl. 399/322; 399/328

(57) ABSTRACT

There are provided a fixing device which includes a first transport path for transporting a recording medium with an image formed thereon and a fixing roll pair having at least one heating roll; and an image forming apparatus including the fixing device. The recording medium transported from the first transport path is nipped and transported to fix the image. The fixing roll pair is placed so that a rotation axis thereof is parallel to a transport surface of the first transport path and tilts with respect to a transport direction of the recording medium in the first transport path. Localized wear of a fixing roll surface caused by edges of a recording medium can be suppressed without limiting the kind of the recording medium used.

This application claims priority on Japanese patent application No. 2004-258355, the entire contents of which are hereby incorporated by reference. In addition, the entire contents of literatures cited in this specification are incorporated herein by reference.

### BACKGROUND OF THE INVENTION

The present invention relates to a fixing device and an image forming apparatus. More specifically, the present invention relates to an image forming apparatus that brings a heating member into contact with an image formed by colorant particles (colored fine particles) on a recording medium to heat-fix the image in an ink-jet printer, an electrophotographic copier, a printers a printing machine, or the like, and to a fixing device used in the image forming apparatus.

As a method of heat-fixing an image formed on a recording sheet using colorant particles in an image forming apparatus such as an ink-jet printer, an electrophotographic copier, a printer, or a printing machine, a so-called heat-roll system is generally used. According to the heat-roll system, a recording sheet with an image formed thereon is transported while being nipped between a heating roll (heat roll) and a pressing roll constituting a fixing roll pair, whereby colorant particles on the recording sheet are molten to be fixed on the recording sheet.

In the heat-roll type fixing device, a large number of recording sheets with the same width pass through the same position of the fixing roll pair. Consequently, there arises a problem that roll surfaces of the fixing roll pair (heating roll and pressing roll) at the positions corresponding to edges of the recording sheet wear out in a localized manner, and in the case of using a recording sheet having a width exceeding the wear-out positions, image quality degrades. More specifically, when the heating roll or the pressing roll wears out partially, heating or pressing is not performed appropriately in the worn-out portion. Therefore, a fixing failure occurs in that portion, and the shape of the worn-out portion is transferred to an image, which causes an image failure (image defect). Consequently, the wear of the roll surface caused by the edges of the recording sheet becomes a limiting factor of the roll life, which brings about an essential problem in the heat-roll type fixing device.

In order to solve the above-mentioned problem, conventionally, measures have been proposed mainly in terms of the roll shape, roll material, sheet material, and the like. For example, it is considered that a portion of a heating roll or a pressing roll that comes into contact with edges of a recording sheet is made softer or harder than the other portions by changing the shape or material thereof, or a recording sheet that is unlikely to wear the roll is used. It is also known that an elastomer material is used for surface layers of both the heating roll and the pressing roll. As a result, the wear caused by the edges of the recording sheet can be minimized (e.g., see JP 08-227248 A).

However, according to the above conventional technique, even if the wear of roll surfaces can be reduced by changing the shape or material of the heating roll and the pressing roll, the roll surfaces corresponding to edge portions still wear out in a localized manner while a large number of recording sheets are transported under pressure. Therefore, the degradation in image quality, which is caused in the case of using a sheet wider than a sheet used frequently, cannot be prevented. Consequently, in spite of the fact that the portions of the roll surface other than those corresponding to the edge portions have not worn out, it is necessary to exchange the rolls in accordance with the wear of the portions corresponding to the edge portions, which is economically disadvantageous.

Furthermore, the use of a dedicated recording sheet that is unlikely to wear the roll surfaces limits the image quality and the use of a recording sheet with an image recorded thereon, which cannot satisfy a variety of needs with respect to image formation. In addition, the use of a special recording sheet leads to an increase in cost.

Furthermore, in particular, in a concentrated electrostatic ink-jet image forming apparatus in which ink with charged colorant particles dispersed in a solvent is used, and the ink, which is concentrated by applying an electrostatic force, is ejected by applying an electrostatic force to form an image, it is possible to record an image with an ultra-high resolution. Therefore, it is important to maintain a high-quality image in a fixing device, and the damage to an image caused by a wear scar of a roll becomes a serious problem. Furthermore, in order to satisfy high-level needs in which an image of high quality is desired to be formed on a variety of recording sheets, it is necessary to make various kinds of recording sheets such as the one that is likely to wear a roll surface usable.

### SUMMARY OF THE INVENTION

It is a first object of the present invention to provide a fixing device of a heat-roll type with which localized wear of a fixing roll surface caused by edges of a recording medium can be suppressed without limiting the kind of the recording medium used.

A second object of the present invention is to provide an image forming apparatus using the fixing device.

In order to achieve the first object of the present invention, there is provided a fixing device including:
a first transport path for transporting a recording medium with an image formed thereon; and
a fixing roll pair which includes at least one heating roll, and in which the recording medium transported from the first transport path is nipped and transported to fix the image,
wherein the fixing roll pair is placed so that a rotation axis thereof is parallel to a transport surface of the first transport path and tilts with respect to a transport direction of the recording medium in the first transport path.

In order to achieve the second object of the present invention, there is also provided an image forming apparatus, including:
forming means for forming an image on a recording medium using colorant-containing particles;
a first transport path for transporting the recording medium with the image formed thereon; and
fixing means for fixing the image by nipping and transporting the recording medium transported from the first transport path in a fixing roll pair, which includes at least one heating roll,
wherein the fixing roll pair is placed so that a rotation axis thereof is parallel to a transport surface of the first transport path, and tilts with respect to a transport direction of the recording medium in the first transport path.

In the fixing device and the image forming apparatus of the present invention, the recording medium is preferably nipped and transported in the fixing roll pair in a direction different from the transport direction of the recording medium in the first transport path; the first transport path preferably includes first driving means for transporting the recording medium; a second transport path for receiving the recording medium transported from the fixing roll pair is preferably included therein; and the second transport path preferably includes second driving means for transporting the recording medium.

Furthermore, in the above-mentioned fixing device or image forming apparatus, it is preferable that the second transport path be placed at a position where the recording medium that was discharged from the fixing roll pair after having been nipped and transported in the fixing roll pair in the transport direction in the first transport path while been shifted in a direction orthogonal to the transport direction in the first transport path is received.

Furthermore, it is preferable that the first transport path transport the recording medium to a side of the fixing roll pair which tilts on a downstream side in the transport direction of the recording medium in the first transport path by using the first driving means, and the second transport path receive and transport the recording medium discharged from a side of the fixing roll pair which tilts on an upstream side in the transport direction of the recording medium in the first transport path by using the second driving means.

Furthermore, in the above-mentioned fixing device or image forming apparatus, it is preferable that one or both of the first transport path and the second transport path be composed of belt transporting means.

Furthermore, it is preferable that the first and second transport paths have a transport width narrower than that of a transport surface of the fixing roll pair, the first transport path be placed on the side where the fixing roll pair tilts on the downstream side in the transport direction, and the second transport path be placed on the side where the fixing roll pair tilts on the upstream side in the transport direction.

In the image forming apparatus, the forming means preferably includes an ink jet head for ejecting ink including the colorant-containing particles to form the image.

In the image forming apparatus, the ink includes charged colorant-containing particles and a solvent, and the forming means applies an electrostatic force to the ink, thereby allowing the ink jet head to eject liquid droplets of the ink to form the image on the recording medium.

According to the present invention, an edge of a recording medium does not come into contact with a particular portion on a fixing roll surface in a localized manner, so that the localized wear of the particular portion on the roll surface can be suppressed. This can prevent image degradation even in the case of using recording media with different sizes, and the life of the roll can be prolonged. Furthermore, even in the case of using a recording medium that is likely to wear a roll surface, such as a thick recording sheet or a hard recording sheet, the wear of the roll surface can be suppressed, so that various kinds of recording media can be used in an image forming apparatus.

Furthermore, according to the present invention, in a concentrated electrostatic ink-jet type image forming apparatus capable of forming an image with an ultra-high resolution, image degradation caused by the wear of a particular portion on a fixing roll surface can be suppressed, and an image can be formed on a variety of recording media, so that the image formed is high in quality.

### BRIEF DESCRIPTION OF THE DRAWINGS

FIGS. 1A and 1B are schematic views each showing a schematic configuration of an image forming apparatus according to an embodiment of the present invention, in which FIG. 1A is a plan view and FIG. 1B is a schematic cross-sectional view showing a positional relationship taken along the line I-I of FIG. 1A.

FIGS. 2A to 2D are schematic plan views illustrating a process in which a recording medium is transported for fixation in a first transport path, fixing means, and a second transport path of an image forming apparatus.

FIGS. 3A and 3B are schematic views each showing a schematic configuration of the image forming apparatus according to another embodiment of the present invention, in which FIG. 3A is a plan view and FIG. 3B is a schematic cross-sectional view showing a positional relationship taken along the line III-III of FIG. 3A.

FIG. 4 is a conceptual view showing a schematic configuration of an embodiment in which the image forming apparatus of the present invention is applied to an electrostatic ink-jet image forming apparatus.

FIG. 5A is a schematic cross-sectional view showing a part of an ejection head, and FIG. 5B is a schematic cross-sectional view taken along the line V-V the FIG. 5A.

### DETAILED DESCRIPTION OF THE PREFERRED EMBODIMENTS

An image forming apparatus and a fixing device according to the present invention will be described in detail by way of preferable embodiments with reference to the accompanying drawings.

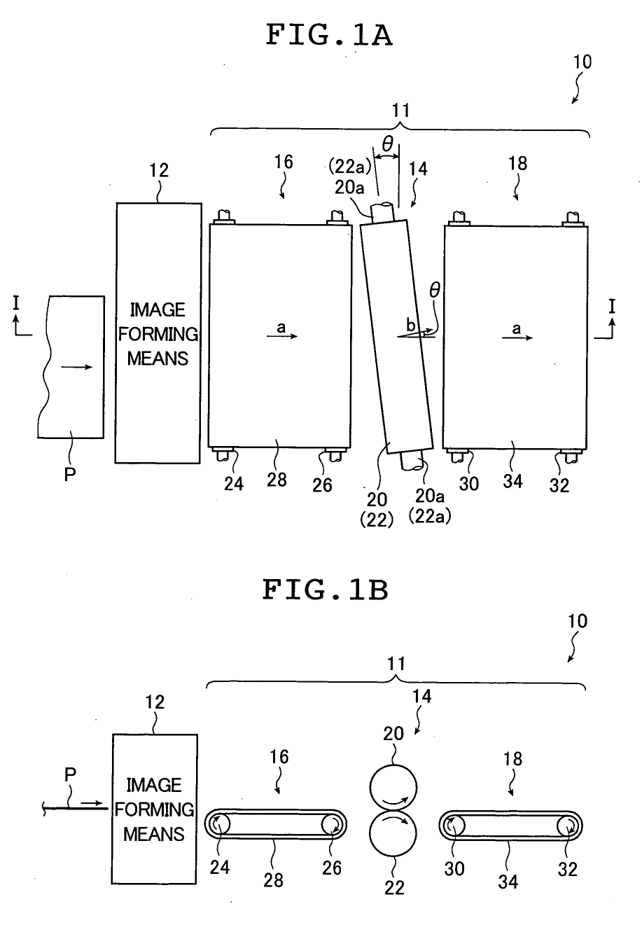

FIGS. 1A and 1B are schematic views each showing a schematic configuration of an image forming apparatus according to an embodiment of the present invention. FIG. 1A is a plan view, and FIG. 1B is a schematic cross-sectional view showing a positional relationship taken along the line I-I of FIG. 1A. An image forming apparatus 10 shown in FIGS. 1A and 1B forms a fixed image on a recording medium P, and includes image forming means 12 for forming an image on the recording medium, fixing means 14 for fixing the formed image, a first transport path 16 for transporting the recording medium P with the image formed thereon by the image forming means 12 to the fixing means 14, and a second transport path 18 for transporting the recording medium P with the image fixed thereon by the fixing means 14 from the fixing means 14. The fixing means 14, the first transport path 16, and the second transport path 18 form a fixing device 11 of the present invention.

As the recording medium P, various kinds of recording media such as paper (plain paper, fine paper, lightweight coated paper, coated paper, art paper, cast coated paper, etc.) and a printing film can be used. There is no particular limit to the shape of the recording medium P. However, hereinafter, the recording medium P in a rectangular shape that is generally used will be described as an example.

In the image forming apparatus 10 in FIGS. 1A and 1B, the recording medium P is transported between the image forming means 12 and the fixing means 14 only by the first transport path 16. However, another transport means may be provided between the image forming means 12 and the first transport path 16. In this case, as the transport means between the image forming means 12 and the first transport path 16, the means which transports the recording medium P without coming into contact with an unfixed image formed on the recording medium P is used as in the first transport path 16 described later.

The image forming means 12 forms an image on the recording medium P using particles containing a colorant. In the illustrated embodiment, the image forming means 12 forms an image on an upper side surface of the recording medium P transported from the left to the right in FIGS. 1A and 1B. As the image forming means 12, various kinds of image forming systems (image recording systems) can be used. For example, various kinds of ink-jet systems such as an electrostatic system, a thermal system, and a piezoelectric system in which ink containing particles containing a colorant such as a pigment (colorant particles) and a solvent is used, and the ink is ejected by an ink-jet system to form an ink image on a recording medium P, an electrophotographic system for forming an image with toner, and the like can be used.

The fixing means 14 fixes the image formed on the recording medium P by the image forming means 12 with a fixing roll pair, and includes a heating roll 20 and a pressing roll 22 forming the fixing roll pair. The fixing means 14 transports the recording medium P nipped between the heating roll 20 and the pressing roll 22, thereby heating and pressing the recording medium P to fix the image formed on the recording medium P. More specifically, owing to the heat and pressure applied by the heating roll 20 and the pressing roll 22, the colorant particles on the recording medium P are softened and molten to adhere to the recording medium P. As a result, the image is fixed.

The heating roll 20 contains a heating source such as a heater or a halogen lamp, and comes into contact with an image recording surface of the recording medium P to heat the recording medium P. The position of the rotation axis of the heating roll 20 is fixed, and the heating roll 20 is driven to rotate by rotation driving means (not shown). Alternatively, in the case where the pressing roll 22 described later is driven to rotate, the heating roll 20 may not be driven to rotate but may be driven with the friction by the pressing roll 22 (rotate in conjunction with the rotation of the pressing roll 22 owing to the friction between the roll surfaces of the heating roll 20 and the pressing roll 22).

The pressing roll 22 is placed so that its axis is in parallel with the axis of the heating roll 20, and presses the heating roll 20 with a predetermined pressure that is uniform in a roll axis direction. Because of this, the recording medium P transported between the heating roll 20 and the pressing roll 22, and the colorant particles on the recording medium P are pressed against the heating roll 20. The pressing roll 22 may be a heating roll having a heating source. Furthermore, the pressing roll 22 is driven to rotate by the rotation driving means (not shown) so that the circumferential velocity at the nipped portion becomes the same as that of the heating roll 20. The rotation driving means of the pressing roll 22 may have a driving source separate from the rotation driving means of the heating roll 20, or may be connected to a common driving source. Furthermore, in the case where the heating roll 20 is driven to rotate, the pressing roll 22 may not be connected to the driving source but may be driven with the friction by the rotating heating roll 20 (rotate in conjunction with the rotation of the heating roll 20 owing to the friction between the roll surfaces of the heating roll 20 and the pressing roll 22).

It is preferable that the surfaces of the heating roll 20 and the pressing roll 22 have an excellent releasability. For example, it is preferable that the surfaces of the heating roll 20 and the pressing roll 22 be made of silicone rubber, fluorocarbon rubber or fluorocarbon resin, and a releasing agent such as oil be applied thereto.

The surface temperature of the heating roll 20 and the pressure of the pressing roll 22 with respect to the recording medium P (nip pressure between the heating roll 20 and the pressing roll 22) may be appropriately set so as to keep a stable fixing property. It is also preferable that the surface layers of the heating roll 20 and the pressing roll 22 be composed of an elastic material, and the recording medium P and the heating roll 20 are brought into surface contact with each other by the pressure from the pressing roll 22, to thereby keep a heating and pressing time sufficient for fixing.

Furthermore, it is preferable that the pressing roll 22 be a driving roll, the heating roll 20 be a driven roll, and the product hardness of the surface of the heating roll 20 be smaller than that of the pressing roll 22.

In the image forming apparatus according to the present invention, a rotation axis 20a of the heating roll 20 and a rotation axis (22a) of the pressing roll 22 are placed so as to be parallel to a transport surface of the recording medium P in the first transport path 16, and tilt with respect to the transport direction of the recording medium P in the first transport path 16. In the image forming apparatus 10 in FIGS. 1A and 1B, the rotation axis 20a of the heating roll 20 and the rotation axis (22a) of the pressing roll 22 are placed so that the transport surface formed by the heating roll 20 and the pressing roll 22 is substantially flush with a transport surface in the first transport path 16 and a transport surface in the second transport path 18, and tilt at an angle (90°−θ) (where 0°<θ<90°) with respect to the transport direction in the first transport path 16 (represented by an arrow a in FIG. 1A). Thus, the transport direction in the heating roll 20 and the pressing roll 22 becomes a direction (represented by an arrow b in FIG. 1A) which tilts at an angle θ with respect to the transport direction in the first transport path 16 (represented by the arrow a).

The first transport path 16 constitutes a path for transporting the recording medium P with an image formed thereon by the image forming means 12 to the fixing means 14. Furthermore, the first transport path 16 has driving means for transporting the recording medium P along the transport path, and includes two rolls 24, 26 that are driven to rotate and a transport belt 28 that is stretched around the rolls 24, 26 and rotates along with the rotation of the rolls 24, 26. The roll 24 is placed near the image forming means 12 on a downstream side thereof with its axis being disposed in a direction orthogonal to the transport direction of the recording medium P in the image forming means 12, and the roll 26 is placed in parallel with the roll 24. The transport belt 28 has a width sufficiently wider than that of the recording medium P, and transports the recording medium P having passed through the image forming means 12 while supporting the surface opposite to the image-formed surface (surface on a lower side in FIG. 1B) in the same direction as the transport direction of the recording medium P during the formation of an image by the image forming means 12.

Furthermore, it is preferable that the first transport path 16 have attraction means (not shown) such as means for attracting the charged recording medium P to the transport belt 28 and means for attracting the recording medium P to the transport belt 28 through sucking from an inner circumferential side of the transport belt 28, in order to transport the recording medium P while holding it on the transport belt 28. The force from the attraction means with which the recording medium P is attracted to the transport belt 28 is set such that the position and posture of the recording medium P is not shifted during the transport by the transport belt 28, and when the recording medium P is transported by the fixing means 14 in the direction represented by the arrow b while being nipped in the fixing means 14, the recording medium P can slide to move on the transport belt 28.

The first transport path 16 need only be configured so that the recording medium P is transported without allowing an unfixed image formed thereon to come into contact with the first transport path 16. In addition to the above configuration, for example, the following may be possible. That is, the recording medium P may be transported by configuring a transport path using a plurality of transport rolls arranged at intervals shorter than the length of the recording medium P in the transport direction on an image-unformed side of the recording medium P.

The second transport path 18 constitutes a path for receiving the recording medium P with an image fixed thereon by the fixing means 14 and transporting it from the fixing means 14 to a subsequent step. Furthermore, the second transport path 18 has driving means for transporting the recording medium P along the transport path, and has the same configuration as that of the first transport path 16. More specifically, the second transport path 18 includes two rolls 30, 32 that are driven to rotate, and a transport belt 34 that is stretched around the rolls 30, 32 and is rotated along with the rotation of the rolls 30, 32. It is preferable that the second transport path 18 further include attraction means (not shown) for attracting the recording medium P to the transport belt 34. As in the attraction means in the first transport path 16, it is desirable that this attraction means also allow the recording medium P to be attracted to the transport belt 34 with a sufficient force to prevent the position and posture of the recording medium P from being shifted during the transport by the transport belt 34 and to allow the recording medium P to slide to move on the transport belt 34 in accordance with the movement of the transport position of the medium that is transported while being nipped in the fixing means 14.

The rolls 30, 32 are placed in parallel with the rolls 24, 26 in the first transport path 16, and in the second transport path 18, the recording medium P is transported in the same direction as that of the transport direction in the first transport path 16 (represented by the arrow a). The transport belt 34 has a width substantially equal to or larger than widths of the roll surfaces of the heating roll 20 and the pressing roll 22 so as to receive the recording medium P transported in the direction represented by the arrow b by the heating roll 20 and the pressing roll 22 within the belt width.

The second transport path 18 need only be configured so as to transport the recording medium P while supporting one surface or both surfaces thereof. In addition to the above configuration, for example, the recording medium P may be transported by configuring a transport path using a plurality of transport rolls or transport roll pairs arranged at intervals shorter than the length of the recording medium P in the transport direction.

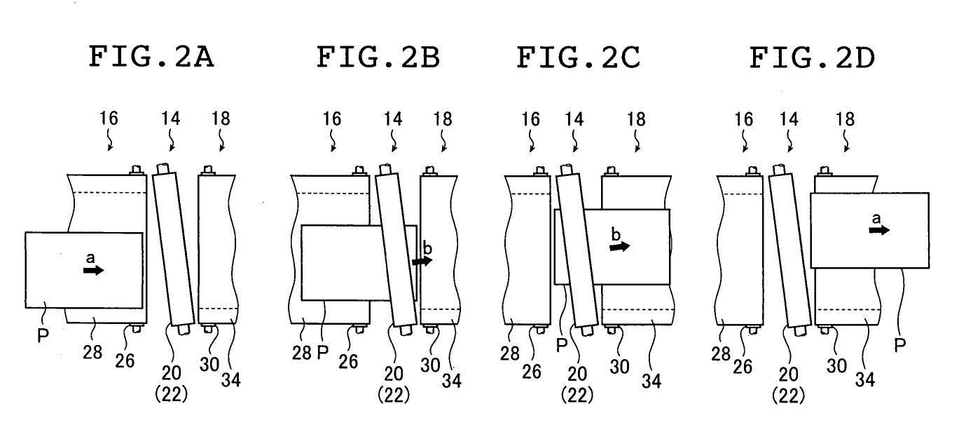

Next, the function of the image forming apparatus 10 will be described. FIGS. 2A to 2D are schematic plan views illustrating a process in which the recording medium P is transported and subjected to fixing in the first transport path 16, the fixing means 14, and the second transport path 18 (i.e., the fixing device 11) in the image forming apparatus 10.

As shown in FIG. 2A, in the first transport path 16, the recording medium P with an image recorded thereon by the image forming means 12 is transported in the direction represented by the arrow a without allowing the image-formed surface to come into contact with the first transport path 16, and sent to the fixing means 14. The image forming means 12, the fixing means 14, and the first transport path 16 are placed so that the recording medium P sent from the image forming means 12 is delivered to one side of the fixing means 14 in the width direction. In FIG. 2A, the recording medium P is delivered to the right side (lower side in FIG. 2A) of the fixing means 14 with respect to the transport direction in the first transport path 16, in other words, to the side of the fixing means 14, which tilts on a downstream side in the transport direction in the first transport path 16.

As shown in FIG. 2B, the recording medium P sent to the fixing means 14 is nipped between the heating roll 20 and the pressing roll 22 of the fixing means 14, and transported in a direction (represented by an arrow b) vertical to the axial direction in the heating roll 20 and the pressing roll 22, with the result that an image is heated and fixed. The transport direction in the fixing means 14 is a direction (represented by the arrow b, see FIG. 1A) which tilts at an angle θ with respect to the transport direction in the first transport path 16 (represented by the arrow a). Therefore, as the recording medium P is transported while being nipped in the fixing means 14, the position in the width direction of the recording medium P (in a vertical direction in FIG. 2B) moves in the tilting direction as represented by the arrow b (direction toward the left side with respect to the transport direction; upward direction in FIG. 2B). At this time, a portion of the recording medium P located on an upstream side of the fixing means 14 slides to move on the surface of the transport belt 28 of the first transport path 16.

As shown in FIG. 2C, a portion of the recording medium P having passed through the fixing means 14 has an image-unformed surface supported by the transport belt 34 of the second transport path 18. While a portion on an upstream side of the recording medium P is nipped in and transported by the fixing means 14, the transport position of the recording medium P in the transport belt 34 moves upward in FIG. 2C, and the recording medium P on the transport belt 34 slides to move on the surface of the transport belt 34.

As shown in FIG. 2D, the recording medium P is discharged from a left side (upper side in FIG. 2D) of the fixing means 14 with respect to the transport direction in the first transport path 16, i.e., from a side of the fixing means 14 which tilts on an upstream side in the transport direction in the first transport path 16. When the trailing edge of the recording medium P passes through the fixing means 14, the recording medium P is transported in the direction represented by the arrow a by the transport belt 34 while remaining in position.

Herein, regarding the heating roll 20 and the pressing roll 22 of the fixing means 14, the position at which the recording medium P nipped (nipped) between the heating roll 20 and the pressing roll 22 is passed therebetween gradually moves along with the forward movement of the recording medium P in a range from the position where the recording medium P is delivered to the fixing means 14 to the position where the recording medium P is discharged therefrom. More specifically, the portion where the edges in the width direction of the recording medium P contacts the heating roll 20 and the pressing roll 22 does not remain at a particular position, but is moved in a large area of the roll surface. Thus, localized wear at the particular position of the roll surfaces can be prevented.

In the image forming apparatus 10 or the fixing device 11, the larger the angle θ formed between the arrangement direction of the heating roll 20 and the pressing roll 22 and the transport direction in the first transport path 16 is, the more the amount of the movement in the transport position of the recording medium P in the width direction is increased. This is preferable in that a portion with which the edge of the recording medium P comes in contact can be changed in a large area, and the life of the roll can be prolonged. However, it is necessary to enlarge the width of the heating roll 20 and the pressing roll 22, and increase the gap in the width direction (orthogonal to the transport direction) between the transport position in the first transport path 16 before the rolls 20, 22 and the transport position in the second transport path 18 after the rolls 20, 22, which results in an increase in size of the apparatus. Thus, the angle θ is preferably set in such a range that the wear of the roll surface by the edges of the recording medium P can be suppressed in an allowable range during the service life set for the heating roll 20 and the pressing roll 22, and the requirement for making the apparatus size more compact is met. In this respect, the angle θ is preferably 0.5° to 15°, more preferably 1° to 8°, and most preferably 2° to 4°.

Furthermore, in the case of using the recording medium P of various sizes in the image forming apparatus 10, the width and the angle θ of the heating roll 20 and the pressing roll 22 may be set so that the whole of the recording medium P of the maximum size passes over substantially the entire width of the roll surfaces of the heating roll 20 and the pressing roll 22. Alternatively, the following is also preferable. Moving means for moving the fixing means 14 that changes the angle θ formed in the fixing means 14 and control means that controls the moving means for the fixing means 14 in accordance with the size of the recording medium P to control the angle θ formed in the fixing means 14 are provided to change the angle θ formed in the fixing means 14 in accordance with the size of the recording medium P to be transported so that the recording medium P of each size can pass over substantially the entire width of the roll surfaces of the heating roll 20 and the pressing roll 22.

In this embodiment, the heating roll 20 and the pressing roll 22 are placed so that the rotation axis 20a of the heating roll 20 and the rotation axis (22a) of the pressing roll 22 tilt at an angle (acute angle) of (90°−θ) with respect to the transport direction in the first transport path 16 (represented by the arrow a in FIG. 1A), and the recording medium P is transported to the lower side of the heating roll 20 and the pressing roll 22 in FIGS. 1A, 2A, etc. However, the heating roll 20 and the pressing roll 22 may tilt in an opposite direction. More specifically, the heating roll 20 and the pressing roll 22 may be placed so that the rotation axis 20a of the heating roll 20 and the rotation axis (22a) of the pressing roll 22 tilt at an angle (obtuse angle) of (90°+θ) with respect to the transport direction in the first transport path 16 (represented by the arrow a in FIG. 1A). In this case, the transport position of the recording medium P passing through the heating roll 20 and the pressing roll 22 moves downward in FIGS. 1A, 2A, etc. Therefore, the recording medium P may be transported to the upper side of the heating roll 20 and the pressing roll 22. More specifically, in any case, the recording medium P is transported to a side of the heating roll 20 and the pressing roll 22 that tilts on a downstream side in the transport direction.

Furthermore, in this embodiment, the widths of the transport belt 28 in the first transport path 16 and the transport belt 34 in the second transport path 18 are set to be substantially equal to the roll widths of the heating roll 20 and the pressing roll 22 of the fixing means 14. However, a transport belt may not be provided in a region where the transport belt 28 or the transport belt 34 does not support the recording medium P, i.e., in a portion on the left side with respect to the transport direction of the transport belt 28 (portion on the upper side in FIGS. 2A to 2D) and a portion on the right side with respect to the transport direction of the transport belt 34 (portion on the lower side in FIGS. 2A to 2D) (see FIGS. 1A-1B and FIGS. 2A-2D). In this case, as represented by broken lines in FIGS. 2A to 2D, the transport belt 28 and the transport belt 34 are set to have widths smaller than the roll widths of the heating roll 20 and the pressing roll 22, and are shifted in a direction orthogonal to the transport direction for arrangement.

A guide plate supporting an image-unformed surface of the recording medium P may also be provided in a gap between the forward edge of the transport belt 28 of the first transport path 16 and the fixing means 14 (between the roll 26 and the pressing roll 22), and a gap between the fixing means 14 and the rear edge of the transport belt 34 of the second transport path 18 (between the pressing roll 22 and the roll 30).

In the image forming apparatus 10 and the fixing device 11 in this embodiment, the first transport path 16 and the second transport path 18 constitute transport paths of the recording medium P using the transport belt 28 and the transport belt 34, respectively, and have driving means (rolls 24, 26, and rolls 30, 32, and optionally a driving source therefor) for driving the transport belt 28 and the transport belt 34, respectively, so as to transport the recording medium P along the transport paths. However, the image forming apparatus and the fixing device of the present invention are not limited thereto. The image forming apparatus 10 and the fixing device 11 may have a member constituting a transport path (e.g., a guide plate, a plurality of arranged idle rolls) as the first or second transport path, and separately have transport means for transporting the recording medium P along the transport path.

Furthermore, in this embodiment, in the first transport path 16, the fixing means 14, and the second transport path 18 (i.e., the fixing device 11), the recording medium P is transported on the transport surfaces substantially flush with each other. For example, the first transport path 16, the fixing means 14, and the second transport path 18 may form a curved transport surface. In this case, the heating roll 20 and the pressing roll 22 are also placed so that the rotation axis 20a of the heating roll 20 and the rotation axis (22a) of the pressing roll 22 are parallel to the transport surface of the recording medium P in the first transport path 16, more specifically, parallel to the transport surface at a moment when the recording medium P is discharged from the first transport path 16 so that the recording medium P is not twisted.

Furthermore, in this embodiment, the recording medium P is transported between the image forming means 12 and the fixing means 14 only with the first transport path 16. Therefore, the transport direction in the first transport path 16 is set to be the same as that in the image forming means 12. However, in the case of providing another transport means between the image forming means 12 and the first transport path 16, the transport direction in the first transport path 16 may not be the same as that in the image forming means 12, but may only be appropriately set in accordance with the configuration of the image forming apparatus 10. The angle θ at which the heating roll 20 and the pressing roll 22 are arranged is determined with respect to the transport direction in the first transport path 16.

Furthermore, in this embodiment, the transport direction in the first transport path 16 is set to be the same as that in the second transport path 18. However, the direction in which the recording medium P having passed through the fixing means 14 is transported may only be appropriately set in accordance with the configuration of the image forming apparatus 10, and the transport direction in the second transport path 18 may be set to be different from that in the first transport path 16.

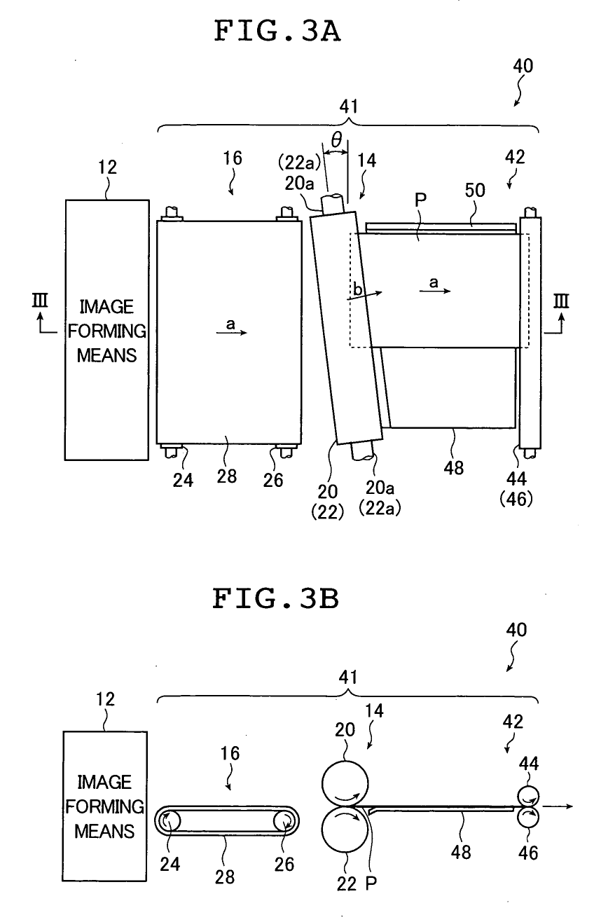

Next, another embodiment of the image forming apparatus and the fixing device according to the present invention will be described with reference to FIGS. 3A and 3B.

FIGS. 3A and 3B are schematic views each showing a schematic configuration of the image forming apparatus according to another embodiment of the present invention. FIG. 3A is a plan view, and FIG. 3B is a schematic cross-sectional view showing a positional relationship taken along the line III-III of FIG. 3A. An image forming apparatus 40 shown in FIGS. 3A and 3B forms a fixed image on the recording medium P as in the image forming apparatus 10 shown in FIGS. 1A and 1B, and has the same configuration as that of the image forming apparatus 10 except that a second transport path 42 made up of transport rolls is used instead of the second transport path 18 that is belt transporting means. Therefore, the same components as those in FIGS. 1A and 1B are denoted by the same reference numerals, and the detailed description thereof is omitted here. The fixing means 14, the first transport path 16, and the second transport path 42 constitute a fixing device 41.

The second transport path 42 includes transport rolls 44, 46 with which the recording medium P is nipped to be transported, and a guide plate 48 which constitutes a transport path of the recording medium P discharged from the fixing means 14 and which guides the recording medium P to the transport rolls 44, 46. The transport rolls 44, 46 are placed in parallel with the rolls 24, 26 of the first transport path 16, and in the second transport path 42, the recording medium P is transported in the same direction as that in the first transport path 16 (represented by the arrow a). The width of the roll surface of each of the transport rolls 44, 46 is set to be substantially equal to or larger than that of the roll surface of each of the heating roll 20 and the pressing roll 22 so as to receive the recording medium P transported in the direction represented by the arrow b by the heating roll 20 and the pressing roll 22 on the roll surface.

Furthermore, the transport rolls 44, 46 are placed at a position where the distance from the nip portion between the transport rolls 44, 46 to the nip portion between the heating roll 20 and the pressing roll 22 at a transport position in the width direction of the recording medium P at which the distance is the shortest is slightly shorter than the length of the recording medium P in the transport direction. More specifically, in FIG. 3A, at a position of a side edge on the right side (lower side in FIG. 3A) with respect to the transport direction of the recording medium P transported between the heating roll 20 and the pressing roll 22, and the transport rolls 44, 46, the distance from the nip portion between the heating roll 20 and the pressing roll 22 to the nip portion of the transport rolls 44, 46 is slightly shorter than the length of the recording medium P. Owing to this configuration, the leading edge of the recording medium P is nipped between the transport rolls 44, 46 immediately before the trailing edge of the recording medium P leaves the heating roll 20 and the pressing roll 22 and is transported.

The guide plate 48 is placed between the pressing roll 22 of the fixing means 14 and the transport roll 46 disposed on the lower side in FIG. 3B, and supports an image-unrecorded surface of the recording medium P. The guide plate 48 has a guide surface covering substantially the entire transport surface between the rolls 22, 46, and the guide surface has satisfactory slidability with respect to the recording medium P. Furthermore, at an edge of the guide plate 48 on the left side (upper side in FIG. 3A) with respect to the transport direction, a guide rail 50 is erected. The guide rail 50 has a function of preventing the recording medium P from coming off the guide plate 48, and adjusting the posture of the recording medium P.

The transport rolls 44, 46 and the guide plate 48 may not be provided in a region that does not support the recording medium P (region on the lower side in FIG. 3A) in the same way as in the second transport path 18 (transport belt 34) in the image forming apparatus 10 shown in FIGS. 1A-1B and 2A-2D, and the transport rolls and the guide plate having a width shorter than that of the roll surfaces of the heating roll 20 and the pressing roll 22 may be provided only in a region to which the recording medium P is discharged and which is located on the left side (upper side in the FIG. 3A) with respect to the transport direction in FIG. 3A.

In the image forming apparatus 40, a portion of the recording medium P having passed through the fixing means 14 has its image-unformed surface supported by the guide plate 48. The recording medium P slides to move on the guide surface of the guide plate 48 when the transport position is moved in the width direction along with the passage of the recording medium P through the fixing means 14. When the trailing edge of the recording medium P passes through the fixing means 14, the posture of the recording medium P on the guide plate 48 may be deformed. However, the recording medium P on the guide plate 48 has a side edge on the left side (upper side in FIG. 3A) with respect to the transport direction as regulated by the guide rail 50, so that the direction of the side edge is matched with the transport direction, and the recording medium P is transported by the transport rolls 44, 46 as it is.

In the case of using a recording medium of various lengths for the recording medium P, the position of the transport rolls 44, 46 may be moved in the transport direction so that the leading edge of the recording medium P is nipped between the transport rolls 44, 46 immediately before the trailing edge of the recording medium P leaves the fixing means 14. In this case, the guide plate 48 is, for example, divided at a center portion in the transport direction so that the guide plate 48 on the side of the transport rolls 44, 46 is also moved along with the movement of the transport rolls 44, 46, and the effective guide length of the guide plate 48 is adjusted by the gap formed between the portions into which the guide plate 48 is divided, whereby the guide function between the fixing means 14 and the transport rolls 44, 46 can be maintained.

Furthermore, when the recording medium P of various sizes is used and the position of the recording medium P discharged from the fixing means 14 changes depending upon the size of the recording medium P, it is also preferable that the position of the guide rail 50 be made adjustable in accordance with the transport position of the recording medium P.

When the recording medium P of various sizes is used and the angle θ formed by the fixing means 14 is changed in accordance with the size of the recording medium P, the guide plate 48 may be divided into a portion in the vicinity of the fixing means 14 and another portion covering from the center of the guide plate 48 to the vicinity of the transport rolls 44, 46, whereby the portion in the vicinity of the fixing means 14 can be moved together with the fixing means 14.

Next, the image forming apparatus and the fixing device of the present invention will be described by way of an embodiment applied to an electrostatic ink-jet image forming apparatus. In a concentrated electrostatic ink-jet image forming apparatus that uses ink with charged colorant particles dispersed in a solvent, and applies an electrostatic force to concentrate ink and eject the concentrated ink to thereby form an image, a high-definition image can be formed. By applying the image forming apparatus and the fixing device of the present invention to such an image forming apparatus, an image formed with high definition is fixed as it is, whereby the image obtained is high in quality.

In the following, an example in which colorant particles in ink are positively charged will be described. Contrary to this, the colorant particles in ink that are negatively charged may be used. In this case, the polarity of each component involved in recording may be reversed with respect to that in the following example.

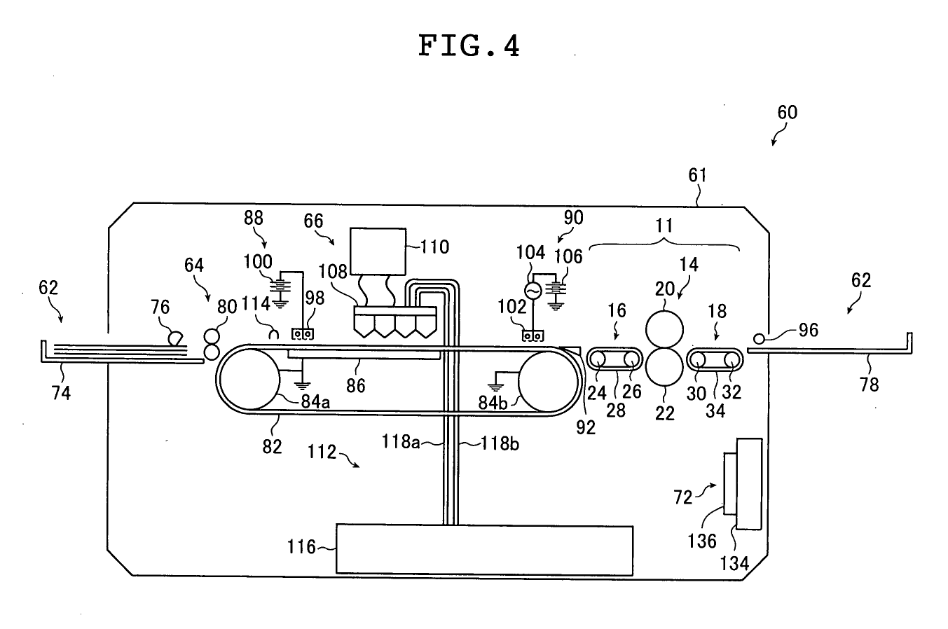

FIG. 4 is a conceptual diagram showing one embodiment of the electrostatic ink-jet image forming apparatus applying the image forming apparatus of the present invention. An ink-jet image forming apparatus 60 shown in FIG. 4 controls the ejection of ink containing charged colorant particles (charged fine particles) by an electrostatic force, performs 4-color printing on the recording medium P to record a full-color image thereon, and thereafter, fixes the recorded image by contact-heating with a heating roll. The ink-jet image forming apparatus 60 includes holding means 62 of the recording medium P, transport means 64, image forming means 66, the fixing means 14, and solvent collecting means 72, and these components are contained in a housing 61. Furthermore, on the upstream side and the downstream side in the transport direction of the fixing means 14, the first transport path 16 and the second transport path 18 are placed respectively.

The fixing means 14, the first transport path 16, and the second transport path 18 constitute the fixing device of the present invention. These components may be configured as a unit, and the unit may be attached to the image forming apparatus 60. Alternatively, these components may be separately incorporated in the image forming apparatus 60 to function as a fixing device.

In the ink-jet image forming apparatus 60 shown in FIG. 4, the fixing means 14, the first transport path 16, and the second transport path 18 are similar to the fixing means 14, the first transport path 16, and the second transport path 18 in the image forming apparatus 10 in FIG. 1. Therefore, the same components are denoted by the same reference numerals, and the detailed description of the same components will be omitted here. Furthermore, the image forming means 66 in the ink-jet image forming apparatus 60 in FIG. 4 correspond to the image forming means 12 in the image forming apparatus 10 in FIGS. 1A and 1B.

First, the holding means 62 for the recording medium P will be described.

The holding means 62 includes a sheet feed tray 74 for holding the recording medium P before recording, a pickup roll 76, and a sheet discharge tray 78 for holding the recording medium P after completion of the recording.

The sheet feed tray 74 holds sheets of the recording medium P supplied for recording, and is inserted in the housing 61 from a left side of the housing 61 in FIG. 4. The pickup roll 76 is placed in the vicinity of a forward end portion (right end portion in FIG. 4) of a mounting portion into which the sheet feed tray 74 is inserted. During recording of an image, the sheets of the recording medium P are taken out one by one from the sheet feed tray 74 by the pickup roll 76 to be supplied to the transport means 64 for the recording medium P. In the vicinity of the pickup roll 76, in order to facilitate the separation of the recording medium P whose sheets are stacked on one another, a discharging brush or a discharging roll for discharging the recording medium P, an air blower and the like are preferably provided.

The sheet discharge tray 78 holds the recording medium P on which an image is formed. The sheet discharge tray 78 is provided at the forward end of the transport path of the recording medium P in the housing 61, and the forward end portion of the tray 78 (forward end side in the transport direction of the recording medium P) is placed outside the housing 61. The recording medium P after completion of the recording is transported by the transport means 64 to be discharged to the sheet discharge tray 78.

Next, the transport means 64 for the recording medium P will be described.

The transport means 64 transports the recording medium P along a predetermined path from the sheet feed tray 74 to the sheet discharge tray 78, and includes a transport roll pair 80, a transport belt 82, rolls 84a, 84b, a conductive platen 86, a charger 88 and a discharger 90 for the recording medium P, a separation claw 92, and a sheet discharging roll 96. The recording medium P is transported by the first transport path 16, the fixing means 14 and the second transport path 18 between the separation claw 92 and the discharging roll 96. As the transport means 64, in addition to the components shown in FIG. 4, ordinary transporting members such as a transport roll pair, a transport belt, and a transporting guide may be arranged as required at appropriate intervals for transporting the recording medium P.

The transport roll pair 80 is provided at a position between the pickup roll 76 and the transport belt 82. The recording medium P taken out of the sheet feed tray 74 by the pickup roll 76 is nipped in the transport roll pair 80 and transported by the transport belt 82 to be supplied to a predetermined position on the transport belt 82.

The transport belt 82 is a loop-shaped endless belt, and stretched around the two rolls 84a, 84b. At least one of the rolls 84a, 84b is connected to a driving source (not shown), and rotated at a predetermined speed during recording. Because of this, the transport belt 82 travels around the rolls 84a, 84b clockwise in FIG. 4, and transports the recording medium P electrostatically attracted to the transport belt 82 at a predetermined speed.

The surface (front surface) of the transport belt 82 to which the recording medium P is electrostatically attracted, has an insulating property, and the surface (reverse surface) thereof which is in contact with the rolls 84a, 84b has conductivity. Furthermore, on an inner surface side of the transport belt 82, the conductive platen 86 is placed over a region extending from a position opposed to the charger 88 to a position opposed to an ink jet head 108, and the rolls 84a, 84b and the conductive platen 86 are grounded. Because of this, the transport belt 82 also functions as a counter electrode of the ink jet head 108 at a position opposed to the ink jet head 108.

It is preferable that the conductive platen 86 be placed so that its upper surface slightly protrudes toward the ink jet head 108 side from a line connecting the circumferences of the rolls 84a and 84b. By placing the conductive platen 86 as described above, tension is applied to the transport belt 82 to suppress flapping.

The charger 88 for the recording medium P includes a scorotron charger 98 and a negative high-voltage source 100. The scorotron charger 98 is placed so as to be opposed to the surface of the transport belt 82 at a position between the transport roll pair 80 and the image forming means 66 in a transport path of the recording medium P. Furthermore, the scorotron charger 98 is connected to a terminal on a negative side of the negative high-voltage source 100, and a terminal on a positive side of the negative high-voltage source 100 is grounded.

The surface of the recording medium P is uniformly charged to a predetermined negative high potential by the scorotron charger 98 connected to the negative high-voltage source 100, and a constant DC bias voltage (e.g., about −1.5 kV) required for recording is applied to the surface. Consequently, the recording medium P is electrostatically attracted to the surface of the transport belt 82 having an insulating property.

The discharger 90 for the recording medium P includes a corotron discharger 102, an AC voltage source 104, and a high-voltage source 106. The corotron discharger 102 is placed so as to be opposed to the surface of the transport belt 82 on a downstream side of the image forming means 66 in the transport direction of the recording medium P. The corotron discharger 102 is connected to the high-voltage source 106 via the AC voltage source 104, and the other terminal of the high-voltage source 106 is grounded.

The recording medium P after the recording is discharged by the corotron discharger 102, and thereafter, is separated from the transport belt 82 by the separation claw 92 placed on a downstream side of the corotron discharger 102. The recording medium P separated from the transport belt 82 is transported on the first transport path 16 to the fixing means 14, subjected to a fixing process by the fixing means 14, transported on the second transport path 18, and is discharged to the sheet discharge tray 78 by the sheet discharging roll 96.

Next, the image forming means 66 will be described.

The image forming means 66 uses ink containing charged colorant particles, and controls the ejection of ink with an electrostatic force in accordance with image data, thereby recording an image on the recording medium P in accordance with the image data. The image forming means 66 includes the electrostatic ink jet head 108, a head driver 110, an ink circulation mechanism 112, and a position detector 114 of the recording medium P.

The ink jet head 108 is placed at a position through which the recording medium P is transported by the transport belt 82 in a stable flat state in the transport path of the recording medium P in such a manner that its ink ejection portion is positioned at a predetermined distance from the surface of the transport belt 82 (surface of the recording medium P held on the surface of the transport belt 82). In the illustrated example, the ink jet head 108 is placed between the rolls 84a and 84b so as to be opposed to the transport belt 82 supported by the conductive platen 86.

The ink jet head 108 is a line head capable of recording an image of one row simultaneously, and is provided with ejection heads of four colors of cyan (C), magenta (M), yellow (Y), and black (B) for recording a full-color image. The ejection head of each color basically has the same configuration, so that an ejection head 160 of one color will be described below.

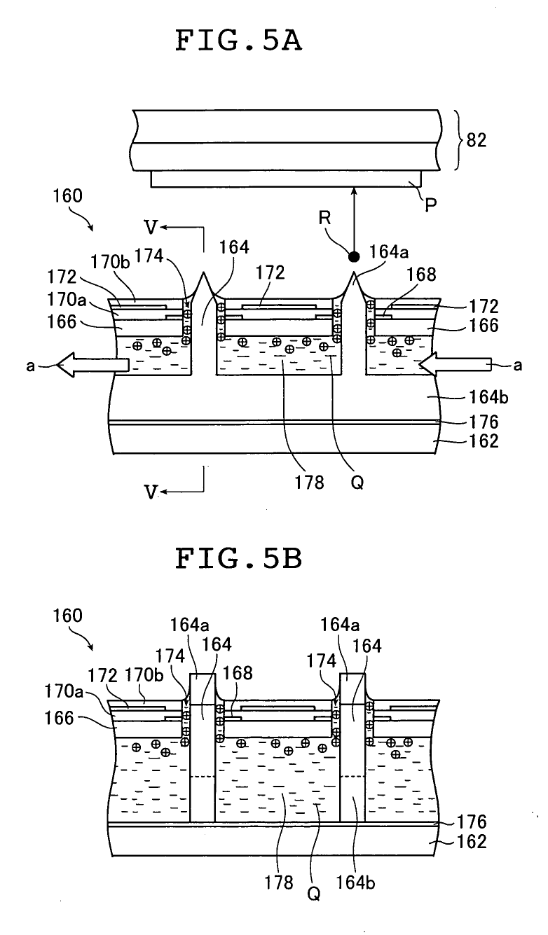

FIGS. 5A and 5B are each schematic view illustrating a specific configuration of the ejection head 160 in the electrostatic ink jet head 108. FIG. 5A is a schematic cross-sectional view showing a part of the ejection head 160, and FIG. 5B is a schematic cross-sectional view taken along the line V-V of FIG. 5A. The ejection head 160 is a multi-channel head provided with nozzles two-dimensionally. Herein, in order to clarify the configuration, only two ejection portions are shown. In FIG. 5A, the transport belt 82 which faces the ejection head 160 is also illustrated, however, the transport belt 82 and the ejection head 160 are illustrated in a positional relation vertically opposite to that shown in FIG. 4.

The ejection head 160 includes a head substrate 162, ink guides 164, a nozzle substrate 166, ejection electrodes 168, and a floating conductive plate 176. The ejection head 160 is placed so that the tip end of the ink guide 164 as the ejection (flying) point of an ink droplet R is opposed to the transport belt 82 which supports the recording medium P and serves as a counter electrode.

The head substrate 162 and the nozzle substrate 166 are flat substrates common to all the nozzles of the ejection head 160, and are made of an insulating material. The head substrate 162 and the nozzle substrate 166 are placed at a predetermined distance from each other, and an ink flow path 178 is formed therebetween. Ink Q in the ink flow path 178 contains colorant particles charged to the voltage identical in polarity to that applied to the ejection electrode 168, and during recording, the ink Q is circulated by the ink circulation mechanism 112 (refer to FIG. 4) in the ink flow path 178 at a predetermined speed (e.g., ink flow rate of 200 mm/s) in a predetermined direction, and in the example shown in FIG. 5A, from the right side to the left side (direction indicated by an arrow a in FIG. 5A). Hereinafter, the case where the colorant particles in ink are positively charged will be described.

In the nozzle substrate 166, nozzles 174 serving as ejection ports for the ink Q are formed, and the nozzles 174 are placed two-dimensionally at predetermined intervals. Furthermore, the ink guide 164 for determining the ejection (flying) point of the ink Q is placed in the center of the nozzle 174.

The ink guide 164 is a plate made of an insulating resin with a predetermined thickness, has a protruding tip end portion 164a, and is placed on the head substrate 162 at a position corresponding to each nozzle 174. The ink guide 164 has a base 164b common to the ink guides 164 arranged in the same column (in a horizontal direction in FIG. 5A, and in a direction vertical to the paper surface of FIG. 5B), and the base 164b is fixed on the head substrate 162 with the floating conductive plate 176 interposed therebetween.

Furthermore, the tip end portion 164a of the ink guide 164 is placed so as to protrude from the outermost surface of the ejection head 160 on the recording medium P (transport belt 82) side. The shape and structure of the tip end portion 164a are set so that the ejection point of the ink Q (ink droplet R) can be stabilized and the ink Q can be sufficiently supplied to the tip end portion 164a, where the colorant particles in the ink Q are concentrated into a preferable state. For example, the tip end portion 164a gradually tapered toward the ejecting direction, the tip end portion 164a in which a slit serving as an ink guide groove is formed in a vertical direction in FIG. 5A, the tip end portion 164a to which a metal is vapor-deposited to substantially increase the dielectric constant of the tip end portion 164a, and the like are preferable.

On the surface (upper surface in FIG. 5A) of the nozzle substrate 166 on the recording medium P side, the ejection electrodes 168 are placed so as to surround the respective nozzles 174. Furthermore, on the recording medium P side of the nozzle substrate 166, an insulating layer 170a covering upper portions (upper surfaces) of the ejection electrodes 168, a sheet-shaped guard electrode 172 placed above the ejection electrodes 168 via the insulating layer 170a, and an insulating layer 170b covering the upper surface of the guard electrode 172 are provided.

The ejection electrodes 168 are placed in a ring shape for each ejection portion (i.e., as circular electrodes) on the upper side of the nozzle substrate 166 in FIG. 5A (i.e., on the surface of the nozzle substrate 166 on the recording medium P side) so as to surround the nozzles 174 formed in the nozzle substrate 166. The ejection electrode 168 is not limited to a circular electrode, and it may be a substantially circular electrode, a divided circular electrode, a parallel electrode, or a substantially parallel electrode.

The ejection electrodes 168 are controlled by the head driver 110, and supplied with a predetermined pulse voltage in accordance with image data. As described above, the recording medium P charged to a voltage opposite in polarity to that of the charged colorant particles in ink is transported to a position opposed to the ink guide 164 at a predetermined speed while being held by the transport belt 82. The recording medium P is charged to a negative high voltage (e.g., −1500 V), and a predetermined electric field which does not cause ejection of the ink Q is formed between the recording medium P and the ejection electrodes 168.

When the ejection electrodes 168 are in an ejection OFF state (ejection stand-by state), a pulse voltage applied is 0V or low. In this state, the electric field intensity in the ejection portion is set by a bias voltage (or a bias voltage superposed on a pulse voltage in the OFF state), which is set lower than the intensity required for ejecting the ink Q, so that the ink Q is not ejected. However, owing to the low electric field in the ejection stand-by state, the colorant particles in ink inside the nozzle 174 are concentrated at the tip end portion 164a of the ink guide 164.

When the ejection electrode 168 is in an ejection ON state, a pulse voltage is applied, and a high pulse voltage (e.g., 400 to 600 V) is superposed on the bias voltage, the electric field intensity of the ejection portion has an intensity sufficient for the ink Q to be ejected, and the ink Q concentrated at the tip end portion 164a of the ink guide 164 flies as the ink droplet R. Since the size of the ink droplet R is very small, a high-quality and high-resolution image can be recorded.

Thus, ON/OFF control is performed on the ejection electrode 168 of each ejection portion arranged over the entire width of the recording medium P in accordance with image data, and ink is ejected at a predetermined timing on the recording medium P transported at a predetermined speed, whereby a two-dimensional image is recorded on the recording medium P.

The guard electrode 172 is placed between the ejection electrodes 168 of adjacent ejection portions, and suppresses the interference of an electric field occurring between the ink guides 164 of adjacent ejection portions. The guard electrode 172 is a sheet-shaped electrode such as a metal plate common to all the ejection portions of the ejection head 160, and portions corresponding to the ejection electrodes 168 formed on the periphery of the respective nozzles 174 arranged two-dimensionally are perforated. By providing the guard electrode 172, even in the case where the nozzles 174 are arranged at a high density, the influence of an electric field of the adjacent nozzles 174 can be minimized, and the dot size and the drawing position of a dot can be kept consistently.

On the surface of the head substrate 162 on the ink flow path 178 side, the floating conductive plate 176 is placed. The floating conductive plate 176 is electrically insulated (in a high impedance state). The floating conductive plate 176 generates an induced voltage in accordance with the value of the voltage applied to the ejection portion during image recording, and allows the colorant particles to migrate to the nozzle substrate 166 side in the ink Q flowing in the ink flow path 178. Furthermore, on the surface of the floating conductive plate 176, an electrically insulating coating film (not shown) is formed, whereby the physical properties and components of ink are prevented from becoming unstable due to charge injection into the ink and the like. As the insulating coating film, the one having resistance to corrosion caused by ink can be used.

By providing the floating conductive plate 176, the colorant particles in the ink Q flowing in the ink flow path 178 are allowed to migrate to the nozzle substrate 166 side to increase the concentration of the colorant particles in the ink Q flowing through the nozzles 174 of the nozzle substrate 166 to a predetermined level to concentrate the ink Q at the tip end portion 164a of the ink guide 164, whereby the concentration of the colorant particles in the ink Q to be ejected in the form of the ink droplet R can be stabilized at the predetermined level.

In the illustrated example, the ejection electrodes have a single layer electrode structure. However, the ejection electrodes may have, for example, a two-layer electrode structure which includes first ejection electrodes connected in a column direction and second ejection electrodes connected in a row direction, and in which the first ejection electrodes and the second ejection electrodes are arranged in a matrix to perform matrix driving. According to such a matrix driving system, the higher integration of the ejection electrodes and the simplification of the driver wiring can be realized simultaneously.

The ink circulation mechanism 112 includes an ink tank 116, a pump (not shown), an ink supply path 118a, and an ink recovery path 118b. The ink tank 116 is placed on the inner bottom surface of the housing 61, and is connected to the ink jet head 108 via the ink supply path 118a and the ink recovery path 118b.

The ink tank 116 contains ink of four colors, each of which contains colorant particles of each color and a dispersion solvent for dispersing the colorant particles. The ink of each color in the ink tank 116 is supplied by the pump to the ejection head of each color in the ink jet head 108 via the ink supply path 118a. Furthermore, excessive ink of each color that has not been used for recording an image is recovered to the ink tank 116 for each color via the ink recovery path 118b.

Next, the ink Q (ink composition) used in the ink jet head 108 will be described. In the electrostatic ink jet head 108, the ink Q containing colorant particles (charged fine particles containing colorant) dispersed in a solvent (ink solvent, carrier liquid) is used.

It is preferable that the carrier liquid (ink solvent) be a dielectric liquid (non-aqueous solvent) having a high electric resistivity (10⁹ Ω cm or more, preferably 10¹⁰ Ω·cm or more). When the carrier liquid having a high electric resistivity is used, it is possible to reduce the possibility that the carrier liquid itself receives charge injection due to the voltage applied by the ejection electrode, whereby the concentration of the charged particles (charged fine particle component) can be increased, and the charged particles can be concentrated. Furthermore, the carrier liquid having a high electric resistivity can also contribute to the prevention of electric conduction between adjacent ejection electrodes. Furthermore, when ink made of liquid having an electric resistivity within the above-mentioned range is used, ink can be ejected satisfactorily even under a low electric field.

The relative permittivity of the dielectric liquid used as the carrier liquid is preferably equal to or smaller than 5, more preferably equal to or smaller than 4, and much more preferably equal to or smaller than 3.5. Such a range is selected for the relative permittivity, whereby the electric field effectively acts on the colorant particles contained in the carrier liquid to facilitate the electrophoresis of the colorant particles.

Note that the upper limit of the specific electrical resistance of the carrier liquid is desirably about 10¹⁶ Ω·cm, and the lower limit of the relative permittivity is desirably about 1.9. The reason why the electrical resistance of the carrier liquid preferably falls within the above-mentioned range is that if the electrical resistance becomes low, then the ejection of the ink droplets under a low electric field becomes worse. Also, the reason why the relative permittivity preferably falls within the above-mentioned range is that if the relative permittivity becomes high, then the electric field is relaxed due to the polarization of the solvent, and as a result the color of dots formed under this condition becomes light, or the bleeding occurs.

Preferred examples of the dielectric liquid used as the carrier liquid include straight-chain or branched aliphatic hydrocarbons, alicyclic hydrocarbons, aromatic hydrocarbons, and the same hydrocarbons substituted with halogens. Specific examples thereof include hexane, heptane, octane, isooctane, decane, isodecane, decalin, nonane, dodecane, isododecane, cyclohexane, cyclooctane, cyclodecane, benzene, toluene, xylene, mesitylene, Isopar C, Isopar E, Isopar G, Isopar H, Isopar L, Isopar M (Isopar: a trade name of EXXON Corporation), Shellsol 70, Shellsol 71 (Shellsol: a trade name of Shell Oil Company), AMSCO OMS, AMSCO 460 Solvent, (AMSCO: a trade name of Spirits Co., Ltd.), a silicone oil (such as KF-96L, available from Shin-Etsu Chemical Co., Ltd.). The dielectric liquid may be used singly or as a mixture of two or more thereof.

For such colorant particles dispersed in the carrier liquid (ink solvent), colorant itself may be dispersed as the colorant particles into the carrier liquid, but dispersion resin particles are preferably contained for enhancement of fixing property. In the case where the dispersion resin particles are contained in the carrier liquid, in general, there is adopted a method in which pigments are covered with the resin material of the dispersion resin particles to obtain particles covered with the resin, or the dispersion resin particles are colored with dyes to obtain the colored particles.

As the color material, pigments and dyes conventionally used in ink compositions for ink jet recording, (oily) ink compositions for printing, or liquid developers for electrostatic photography may be used.

Pigments used as color material may be inorganic pigments or organic pigments commonly employed in the field of printing technology. Specific examples thereof include but are not particularly limited to known pigments such as carbon black, cadmium red, molybdenum red, chrome yellow, cadmium yellow, titanium yellow, chromium oxide, viridian, cobalt green, ultramarine blue, Prussian blue, cobalt blue, azo pigments, phthalocyanine pigments, quinacridone pigments, isoindolinone pigments, dioxazine pigments, threne pigments, perylene pigments, perinone pigments, thioindigo pigments, quinophthalone pigments, and metal complex pigments.

Preferred examples of dyes used as color material include oil-soluble dyes such as azo dyes, metal complex salt dyes, naphthol dyes, anthraquinone dyes, indigo dyes, carbonium dyes, quinoneimine dyes, xanthene dyes, aniline dyes, quinoline dyes, nitro dyes, nitroso dyes, benzoquinone dyes, naphthoquinone dyes, phthalocyanine dyes, and metal phthalocyanine dyes.

Further, examples of dispersion resin particles include rosins, rosin-modified phenol resin, alkyd resin, a (meth)acryl polymer, polyurethane, polyester, polyamide, polyethylene, polybutadiene, polystyrene, polyvinyl acetate, acetal-modified polyvinyl alcohol, and polycarbonate.

Of those, from the viewpoint of ease for particle formation, a polymer having a weight average molecular weight in a range of 2,000 to 1,000,000 and a polydispersity (weight average molecular weight/number average molecular weight) in a range of 1.0 to 5.0 is preferred. Moreover, from the viewpoint of ease for the fixation, a polymer in which one of a softening point, a glass transition point, and a melting point is in a range of 40° C. to 120° C. is preferred.

In ink Q, the content of colorant particles (total content of colorant particles and dispersion resin particles) preferably falls within a range of 0.5 to 30.0 wt % for the overall ink, more preferably falls within a range of 1.5 to 25.0 wt %, and much more preferably falls within a range of 3.0 to 20.0 wt %. If the content of colorant particles decreases, the following problems become easy to arise. The density of the printed image is insufficient, the affinity between the ink Q and the surface of a recording medium P becomes difficult to obtain to prevent the image firmly stuck to the surface of the recording medium P from being obtained, and so forth. On the other hand, if the content of colorant particles increases, problems occur in that the uniform dispersion liquid becomes difficult to obtain, the clogging of the ink Q is easy to occur in the ink jet head 108 or the like to make it difficult to obtain the stable ink ejection, and so forth.

In addition, the average particle diameter of the colorant particles dispersed in the carrier liquid preferably falls within a range of 0.1 to 2.0 μm, more preferably falls within a range of 0.2 to 1.5 μm, and much more preferably falls within a range of 0.4 to 1.0 μm. Those particle diameters are measured with CAPA-500 (a trade name of a measuring apparatus manufactured by HORIBA LTD.).

After the colorant particles and optionally a dispersing agent are dispersed in the carrier liquid, a charging control agent is added to the resultant carrier liquid to charge the colorant particles, and the charged colorant particles are dispersed in the resultant liquid to thereby produce the ink Q. Note that in dispersing the colorant particles in the carrier liquid, a dispersion medium may be added if necessary.

As the charging control agent, for example, various ones used in the electrophotographic liquid developer can be utilized. In addition, it is also possible to utilize various charging control agents described in “DEVELOPMENT AND PRACTICAL APPLICATION OF RECENT ELECTRONIC PHOTOGRAPH DEVELOPING SYSTEM AND TONER MATERIALS”, pp. 139 to 148; “ELECTROPHOTOGRAPHY-BASES AND APPLICATIONS”, edited by THE IMAGING SOCIETY OF JAPAN, and published by CORONA PUBLISHING CO. LTD., pp. 497 to 505, 1988; and “ELECTRONIC PHOTOGRAPHY” by Yuji Harasaki, 16(No. 2), p. 44, 1977.

The colorant particles are charged particles identical in polarity to the drive voltages applied to the ejection electrodes. The charging amount of the colorant particles is preferably in a range of 5 to 200 μC/g, more preferably in a range of 10 to 150 μC/g, and much more preferably in a range of 15 to 100 μC/g.

In addition, the electrical resistance of the dielectric liquid may be changed by adding the charging control agent in some cases. Thus, the distribution factor P defined below is preferably equal to or larger than 50%, more preferably equal to or larger than 60%, and much more preferably equal to or larger than 70%.
P=100×(σ1−σ2)/σ1
where σ1 is an electric conductivity of the ink Q, and σ2 is an electric conductivity of a supernatant liquid which is obtained by inspecting the ink Q with a centrifugal separator. Those electric conductivities were obtained by measuring the electric conductivities of the ink Q and the supernatant liquid under a condition of an applied voltage of 5 V and a frequency of 1 kHz using an LCR meter of an AG-4311 type (manufactured by ANDO ELECTRIC CO., LTD.) and electrode for liquid of an LP-05 type (manufactured by KAWAGUCHI ELECTRIC WORKS, CO., LTD.). In addition, the centrifugation was carried out for 30 minutes under a condition of a rotational speed of 14,500 rpm and a temperature of 23° C. using a miniature high speed cooling centrifugal machine of an SRX-201 type (manufactured by TOMY SEIKO CO., LTD.).

The ink Q as described above is used, which results in that the colorant particles are likely to migrate and hence the colorant particles are easily concentrated.

The electric conductivity of the ink Q is preferably in a range of 100 to 3,000 pS/cm, more preferably in a range of 150 to 2,500 pS/cm, and much more preferably in a range of 200 to 2,000 pS/cm. The range of the electric conductivity as described above is set, resulting in that the applied voltages to the ejection electrodes are not excessively high, and also there is no anxiety to cause the electrical conduction between the adjacent ejection electrodes.

In addition, the surface tension of the ink Q is preferably in a range of 15 to 50 mN/m, more preferably in a range of 15.5 to 45.0 mN/m, and much more preferably in a range of 16 to 40 mN/m. The surface tension is set in this range, resulting in that the applied voltages to the ejection electrodes are not excessively high, and also the ink does not leak or spread to the periphery of the head to contaminate the head.

Moreover, the viscosity of the ink Q is preferably in a range of 0.5 to 5.0 mPa·sec, more preferably in a range of 0.6 to 3.0 mPa·sec, and much more preferably in a range of 0.7 to 2.0 mPa·sec.

The ink Q can be prepared for example by dispersing colorant particles into a carrier liquid to form particles and adding a charging control agent to the dispersion medium to allow the colorant particles to be charged. The following methods are given as the specific methods.

(1) A method including: previously mixing (kneading) a colorant and optionally dispersion resin particles; dispersing the resultant mixture into a carrier liquid using a dispersing agent when necessary; and adding the charging control agent thereto.

(2) A method including: adding a colorant and optionally dispersion resin particles and a dispersing agent into a carrier liquid at the same time for dispersion; and adding the charging control agent thereto.

(3) A method including adding a colorant and the charging control agent, and optionally the dispersion resin particles and the dispersing agent into a carrier liquid at the same time for dispersion.

The position detector 114 for the recording medium P is conventionally known position detecting means such as a photosensor, and is placed so as to be opposed to the surface of the transport belt 82 by which the recording medium P is transported, at a predetermined position (position between the transport roll pair 80 and the charger 88 in the illustrated example) on an upstream side of the ink jet head 108 in a transport path of the recording medium P. The positional information on the recording medium P as detected by the position detector 114 is supplied to the head driver 110.

The head driver 110 is a driver of the ink jet head 108, and is connected to the ink jet head 108 via a driving signal cable. In the illustrated example, the head driver 110 is attached to a central upper portion in the housing 61. Image data is input to the head driver 110 from an external apparatus, and the positional information on the recording medium P is input thereto from the position detector 114. While the ejection timing of the ejection head of each color in the ink jet head 108 is controlled in accordance with the positional information on the recording medium P, the ink of each color is ejected from the ejection head for each color in accordance with image data, whereby a full color image corresponding to the image data is recorded on the recording medium P.

Next, the fixing means 14, the first transport path 16, and the second transport path 18 (fixing device 11) that are characteristic portions of the present invention will be described. The fixing means 14, the first transport path 16, and the second transport path 18 have the same configuration as those shown in the image forming apparatus 10 in FIG. 1.

More specifically, in the fixing means 14, the recording medium P is nipped between the heating roll 20 and the pressing roll 22 and transported to heat-fix an ink image formed on the recording medium P by the image forming means 66. As in the above example, the heating roll 20 and the pressing roll 22 may be both heating rolls, and the surface temperature of the heating roll 20 and the pressure (nip pressure) applied to the recording medium P by the pressing roll 22 may be appropriately set so that a stable fixing property is ensured.

Furthermore, the heating roll 20 and the pressing roll 22 are placed so that both of the rotation axes are parallel to the transport surface of the recording medium P in the first transport path 16, and tilt with respect to the transport direction of the recording medium P in the first transport path 16.

The first transport path 16 has the two rolls 24, 26 that are driven to rotate and the transport belt 28 that is stretched around the rolls 24, 26 and is rotated along with the rotation of the rolls 24, 26. The first transport path 16 transports the recording medium P on which an image is formed by the image forming means 66 and which is transported by the transport belt 82 and separated from the transport belt 82 by the separation claw 92, in the same direction as the transport direction of the transport belt 82, and delivers it to the fixing means 14.

The second transport path 18 has the two rolls 30, 32 that are driven to rotate, and the transport belt 34 that is stretched around the rolls 30, 32 and is rotated along with the rotation of the rolls 30, 32. The second transport path 18 receives the recording medium P with an image fixed thereon by the fixing means 14 and transports the recording medium P in the same direction as that in the first transport path 16 to send it to the sheet discharging roll 96.

Next, the solvent colleting means 72 will be described.

The solvent collecting means 72 collects a dispersion solvent evaporated from ink ejected from the ink jet head 108 to the recording medium P, a dispersion solvent evaporated from ink during fixing of an image, and the like, and includes an activated carbon filter 134 and an exhaust fan 136. The activated carbon filter 134 is attached to an inner surface of the housing 61 on the right side in FIG. 4, and the exhaust fan 136 is attached onto the activated carbon filter 134.

The air containing dispersion solvent components inside the housing 61 generated by the natural evaporation of the ink solvent from the ink ejected from the ink jet head 108, the natural evaporation of the ink solvent forming an unfixed image on the recording medium P, and the evaporation of the ink solvent generated during fixing by the fixing means 14 are collected by the exhaust fan 136 and passes through the activated carbon filter 134, whereby the solvent components are removed by being adsorbed to the activated carbon filter 134, and the air with the dispersion solvent components removed therefrom is exhausted to the outside of the housing 61.

Hereinafter, the function of the ink jet recording apparatus 60 will be described.

At the time of starting the recording operation, sheets of the recording medium P in the sheet feed tray 74 is taken out one by one by the pickup roll 76, nipped in the transport roll pair 80 and transported to be supplied to a predetermined position on the transport belt 82. The recording medium P supplied onto the transport belt 82 is charged to a negative high potential by the charger 88, and electrostatically attracted to the surface of the transport belt 82.

While the recording medium P electrostatically attracted to the surface of the transport belt 82 is moved at a predetermined constant speed along with the movement of the transport belt 82, an image corresponding to image data is recorded on the surface of the recording medium P by the ink jet head 108.

The recording medium P after the completion of the image recording is discharged by the discharger 90, separated from the transport belt 82 by the separation claw 92, and is transported on the first transport path 16 to be supplied to the fixing means 14.

In the fixing means 14, the recording medium P is nipped between the heating roll 20 and the pressing roll 22 which are placed so that the transport direction in the rolls 20, 22 tilts with respect to that in the first transport path 16, and transported the recording medium P also moves in the width direction along with the transport. Such a transport mechanism prevents the edges of the recording medium P in the width direction from coming into contact with the heating roll 20 and the pressing roll 22 at a particular position in a localized manner, whereby the contact position is changed in a large area of the roll surface. Thus, the rolls can be prevented from wearing out at the particular position of the roll surface in a localized manner.

The recording medium P having passed through the fixing means 14 is transported in the second transport path 18, discharged to the discharge tray 78 by the sheet discharging roll 96, and stocked in the discharge tray 78.

The image forming apparatus and the fixing device according to the present invention have been described in detail. However, the present invention is not limited to the above-mentioned various embodiments, and may be variously changed and modified without departing from the spirit of the present invention.

What is claimed is:

1. A fixing device comprising:
a first transport path for transporting a recording medium with an image formed thereon; and
a fixing roll pair which includes at least one heating roll, and in which the recording medium transported from the first transport path is nipped and transported to fix the image,
wherein the fixing roll pair is placed so that a rotation axis thereof is parallel to a transport surface of the first transport path and tilts with respect to a transport direction of the recording medium in the first transport path.

2. The fixing device according to claim 1, wherein the recording medium is nipped and transported in the fixing roll pair in a direction different from the transport direction of the recording medium in the first transport path.

3. The fixing device according to claim 1, wherein the first transport path comprises first driving means for transporting the recording medium.

4. The fixing device according to claim 1, further comprising a second transport path for receiving the recording medium transported from the fixing roll pair.

5. The fixing device according to claim 4, wherein the second transport path comprises second driving means for transporting the recording medium.

6. The fixing device according to claim 4, wherein the second transport path is placed at a position where the recording medium that was discharged from the fixing roll pair after having been nipped and transported in the fixing roll pair in the transport direction in the first transport path while been shifted in a direction orthogonal to the transport direction in the first transport path is received.

7. The fixing device according to claim 4, wherein the first transport path transport the recording medium to a side of the fixing roll pair which tilts on a downstream side in the transport direction of the recording medium in the first transport path by using the first driving means, and the second transport path receive and transport the recording medium discharged from a side of the fixing roll pair which tilts on an upstream side in the transport direction of the recording medium in the first transport path by using the second driving means.

8. The fixing device according to claim 4, wherein one or both of the first transport path and the second transport path are composed of belt transporting means.

9. The fixing device according to claim 4, wherein the first and second transport paths have a transport width narrower than that of a transport surface of the fixing roll pair, the first transport path is placed on the side where the fixing roll pair tilts on the downstream side in the transport direction, and the second transport path is placed on the side where the fixing roll pair tilts on the upstream side in the transport direction.

10. An image forming apparatus, comprising:
forming means for forming an image on a recording medium using colorant-containing particles;
a first transport path for transporting the recording medium with the image formed thereon; and
fixing means for fixing the image by nipping and transporting the recording medium transported from the first transport path in a fixing roll pair, which includes at least one heating roll,
wherein the fixing roll pair is placed so that a rotation axis thereof is parallel to a transport surface of the first transport path, and tilts with respect to a transport direction of the recording medium in the first transport path.

11. The image forming apparatus according to claim 10, wherein the recording medium is nipped and transported in the fixing roll pair in a direction different from the transport direction of the recording medium in the first transport path.

12. The image forming apparatus according to claim 10 or 11, wherein the first transport path comprises first driving means for transporting the recording medium.

13. The image forming apparatus according to claim 10, further comprising a second transport path for receiving the recording medium transported from the fixing roll pair.

14. The image forming apparatus according to claim 13, wherein the second transport path comprises second driving means for transporting the recording medium.

15. The image forming apparatus according to claim 13, wherein the second transport path is placed at a position where the recording medium that was discharged from the fixing roll pair after having been nipped and transported in the fixing roll pair in the transport direction in the first transport path while been shifted in a direction orthogonal to the transport direction in the first transport path is received.

16. The image forming apparatus according to claim 13, wherein the first transport path transport the recording medium to a side of the fixing roll pair which tilts on a downstream side in the transport direction of the recording medium in the first transport path by using the first driving means, and the second transport path receive and transport the recording medium discharged from a side of the fixing roll pair which tilts on an upstream side in the transport direction of the recording medium in the first transport path by using the second driving means.

17. The image forming apparatus according to claim 13, wherein one or both of the first transport path and the second transport path are composed of belt transporting means.

18. The image forming apparatus according to claim 13, wherein the first and second transport paths have a transport width narrower than that of a transport surface of the fixing roll pair, the first transport path is placed on the side where the fixing roll pair tilts on the downstream side in the transport direction, and the second transport path is placed on the side where the fixing roll pair tilts on the upstream side in the transport direction.

19. The image forming apparatus according to claim 10, wherein the forming means comprises an ink jet head for ejecting ink including the colorant-containing particles to form the image.

20. The image forming apparatus according to claim 19, wherein the ink includes charged colorant-containing particles and a solvent, and
the forming means applies an electrostatic force to the ink, thereby allowing the ink jet head to eject liquid droplets of the ink to form the image on the recording medium.
